(19) United States
(12) Patent Application Publication
(10) Pub. No.: US 2026/0249620 A1
(43) Pub. Date: Aug. 27, 2026

(54) A CONTROLLER, SYSTEM, AND METHOD FOR GENERATING THREAD COLORING DATA FOR AT LEAST ONE THREAD BASED ON A DIGITAL REPRESENTATION

(71) Applicant: COLOREEL INTERNATIONAL HOLDINGS LIMITED, Hong Kong (CN)

(72) Inventors: Joakim Staberg, Hong Kong (CN); Elias Nilsson, Hong Kong (CN); Michael Almroth, Hong Kong (CN)

(21) Appl. No.: 18/877,493

(22) PCT Filed: Jun. 15, 2023
(86) PCT No.: PCT/SE2023/050600

§ 371 Date: Dec. 20, 2024

(30) Foreign Application Priority Data
Jun. 21, 2022 (SE) 2250762-8

(51) Int. Cl. B41J 3/407; D06P 1/00

(52) U.S. Cl. CPC B41J 3/4078; D06P 1/0096; B41J 2203/00

(57) ABSTRACT

A controller (200) configured to generate thread coloring data for a thread that is to be used in a creation of a decorative thread pattern is provided. The controller (200) is further configured to generate said thread coloring data based on a digital representation that is to be produced as the decorative thread pattern by obtaining pattern data from the digital representation (10), the pattern data comprising a plurality of pixels, each pixel being associated with a position (p) in the digital representation (10) and a color value (cv), generating resolution data by processing the pattern data, wherein processing the pattern data comprises determining a thread arrangement comprising a plurality of consecutive thread portions, wherein the entire thread arrangement corresponds to the digital representation to be produced, and generating thread coloring data for the thread (20) at least based on said resolution data.

This application is a national stage entry of International Patent Application No. PCT/SE2023/050600, filed 15 Jun. 2023, which claims the benefit of SE Patent Application No. 2250762-8, filed 21 Jun. 2022, the entire content of each application is incorporated herein by reference.

### TECHNICAL FIELD

The present disclosure relates to a controller for generating thread coloring data for at least one thread based on a digital representation. The present disclosure also relates to an associated system and method.

### BACKGROUND

The concept of converting a photography into an embroidery pattern, also known as photo embroidery, has been employed in the prior art. Photo embroidery generally involves a first step of uploading a digital image into a controller, or in some other way retrieving a digital image. The digital image may be practically any type of digital reproduction of one or more physical or virtual objects, e.g. sculptures, themes, logos, persons, animals, sceneries, and so forth. The digital image comprises a plurality of pixels, wherein each pixel represents a particular color which pertains to, for instance, the RGB or CMYK color space. Photo embroidery methods employed in the art further involve retrieving color data associated with the pixels. Color data is retrieved by processing the respective pixels in the digital image and, for each pixel, deriving a thread color that corresponds to the color data associated with the pixels. As an example, a pixel may be selected that has the RGB color value (0, 128, 128). Accordingly, the thread color teal is selected to represent said pixel, and possibly also a number of additional pixels in the vicinity of the selected pixel. Other type of information is also retrieved in order to properly reproduce the digital image as an embroidery pattern, such as e.g. information related to color transitions and needle placement positions. Once all of the pixels in the digital image have been processed and a set of colored thread reels selected corresponding to the best image reproduction, the embroidery pattern is typically sewn onto a fabric by appropriately switching between the reels of colored threads and performing changes in needle placement positions in the fabric.

In-line thread coloring is a technique that has been applied in prior art systems. In-line thread coloring is advantageous in several aspects, one of which being related to that only a single thread color is required for creating advanced embroidery patterns. For in-line thread coloring, a controller is typically coupled with a coloring device and adapted to control the coloring device to dispense one or more coloring substances onto the thread during movement. The thread may then travel to e.g. a thread consuming device which is operable to consume the in-line thread colored thread for creating an embroidery pattern.

The prior art does not comprise any solution for performing photo embroidery in an in-line thread coloring process. It is thus not known how to perform photo embroidery with in-line thread coloring such that the colors of the resulting embroidery pattern are accurately reproduced, the resolution satisfactory, and/or the transitional colors accurate. Moreover, it is not known how to manage different types of stitches and stitching directions, how to manage abrupt changes in colors in the digital images, or how to manage inherent variations in thread consumption of the associated thread consuming device.

The present inventors have identified the above mentioned deficiencies in the prior art and have insightfully come up with a solution for photo embroidery in in-line thread coloring processes.

### SUMMARY

An object of the present disclosure is therefore to provide a solution to, or at least a mitigation of, one or more of the problems or drawbacks identified in the background section above.

A controller configured to generate thread coloring data for a thread that is to be used in a creation of a decorative thread pattern is provided. The controller is further configured to generate said thread coloring data based on a digital representation that is to be produced as the decorative thread pattern by obtaining pattern data from the digital representation, the pattern data comprising a plurality of pixels, each pixel being associated with a position in the digital representation and a color value, generating resolution data by processing the pattern data, wherein processing the pattern data comprises determining a thread arrangement comprising a plurality of consecutive thread portions, wherein the entire thread arrangement corresponds to the digital representation to be produced, and generating thread coloring data for the thread at least based on said resolution data.

In one embodiment, processing the pattern data further comprises determining information relating to the length of the thread portions, the direction of the thread portions and/or the type of connection used to connect one or more thread portions to each other.

In one embodiment, generating coloring data for the thread comprises transforming the color values to the resolution data; and extracting color data from said transformed color values in order of a production path as defined by the arrangement of the thread portions in relation to each other.

In one embodiment, generating the resolution data further comprises selecting a first pixel among the plurality of pixels, wherein the position of the first pixel and the production path direction represents a first pixel portion, wherein a plurality of rows are defined in parallel with one another in the direction of the first pixel portion, calculating a first resolution as a maximum number of connections fitting a corresponding row, and calculating a second resolution as a maximum number of connections fitting a column being substantially perpendicular to a corresponding row, wherein the resolution data is defined by the first and second resolutions.

In one embodiment, generating the resolution data further comprises selecting a first pixel among the plurality of pixels, wherein the position of the first pixel and the production path direction represents a first axis, wherein a plurality of rows are defined in parallel with one another in the direction of the first axis, calculating a first resolution as a maximum number of connections fitting a corresponding row, and calculating a second resolution as a maximum number of connections fitting a column being perpendicular to a corresponding row, wherein the resolution data is defined by the first and second resolutions.

In one embodiment, generating the resolution data further comprises selecting a first pixel among the plurality of pixels, wherein the position of the first pixel and the production path direction represents a first pixel portion, wherein a plurality of rows are defined in parallel with one another in the direction of the first pixel portion, calculating a first resolution as a maximum number of connections fitting a column being substantially perpendicular to a corresponding row, and calculating a second resolution as a maximum number of connections fitting a corresponding row, wherein the resolution data is defined by the first and second resolutions.

In one embodiment, generating the resolution data further comprises selecting a first pixel among the plurality of pixels, wherein the position of the first pixel and the production path direction represents a first axis, wherein a plurality of rows are defined in parallel with one another in the direction of the first axis, calculating a first resolution as a maximum number of connections fitting a column being perpendicular to a corresponding row, and calculating a second resolution as a maximum number of connections fitting a corresponding row, wherein the resolution data is defined by the first and second resolutions.

In one embodiment, the controller further comprising grouping connections according to the resolution data.

In one embodiment, generating thread coloring data for the thread comprises generating transitional colors for underlay connections.

In one embodiment generating transitional colors for said underlay connections comprises retrieving color data from a first edge portion defined by the thread coloring data, the first edge portion corresponding to a first row, retrieving color data from a second edge portion defined by the thread coloring data, the second edge portion being opposite from the first edge portion and corresponding to a row subsequent and parallel to the first row, generating a color gradient comprising a combination of the color data of the first edge portion and the second edge portion, replacing the color data in the first and second edge portions with color data of the color gradient, and for each subsequent pair of edge portions defined by the thread coloring data, repeating the procedure of retrieving color data from edge portions, generating a color gradient comprising a combination of said retrieved color data, and replacing the color data of the edge portions with the color gradient.

In one embodiment, generating transitional colors for underlay connection comprises retrieving color data from a first edge defined by the thread coloring data, retrieving color data from a second edge defined by the thread coloring data, generating a color gradient comprising a combination of the color data of the first edge and the second edge, and replacing the color data in the right and left edges with color data of the color gradient.

In one embodiment, generating the color gradient comprises aligning the first and second edges in parallel and subsequent to one another, partitioning the aligned edges into a plurality of portions, and combining the color data of the respective portions according to a color transitioning scheme.

In a second aspect, a system for treatment of a thread to be used in a decorative thread pattern is provided. The system comprises the controller according to the first aspect, and further comprises a treatment unit comprising at least one discharge device being configured to dispense one or more coating substances onto the thread when activated. The controller may be further configured to control the dispensing from the discharge device on the thread based on the thread coloring data.

In one embodiment, the system is for in-line treatment of a thread, and wherein the system is in operative communication with a thread consuming unit that is configured to produce the decorative thread pattern.

In a third aspect a method for generating thread coloring data for a thread that is to be used in a creation of a decorative thread pattern is provided. The method comprises generating said thread coloring data based on a digital representation that is to be produced as the decorative thread pattern by obtaining pattern data from the digital representation, the pattern data comprising a plurality of pixels, each pixel being associated with a position in the digital representation and a color value, generating resolution data by processing the pattern data, wherein processing the pattern data comprises determining a thread arrangement comprising a plurality of consecutive thread portions, wherein the entire thread arrangement corresponds to the digital representation to be produced; and generating thread coloring data for the thread at least based on said resolution data.

It should be emphasized that the term “comprises/comprising” when used in this specification is taken to specify the presence of stated features, integers, steps, or components, but does not preclude the presence or addition of one or more other features, integers, steps, components, or groups thereof. All terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale; emphasis instead being placed upon illustrating the example embodiments.

FIG. 1a is a schematic block diagram of a system for use with a thread consuming device according to one embodiment.

FIG. 1b is a schematic illustration of a system for use with a thread consuming device according to one embodiment.

FIG. 2 illustrates a method for generating in-line thread coloring data for a thread based on a digital image according to one embodiment.

FIGS. 3a-c illustrate a method for generating resolution data for a thread using straight stitches according to one embodiment.

FIGS. 4a-e illustrate a method for generating resolution data for a thread using satin stitches according to one embodiment.

FIG. 5a illustrates a method for generating in-line thread coloring data for a thread using straight stitches according to one embodiment.

FIG. 5b illustrates a method for generating in-line thread coloring data for a thread using satin stitches according to one embodiment.

FIGS. 6a-b is an illustration of a conversion error when transforming a digital image into a pattern to be produced according to one embodiment.

FIG. 7 illustrates providing coloring data for underlay stitches according to one embodiment.

FIGS. 8a-d illustrate providing coloring data for underlay stitches according to one embodiment.

FIG. 9 illustrates a method for generating in-line thread coloring data for a thread based on a digital image according to one embodiment.

FIG. 10 illustrates a controller configured to control generation of in-line thread coloring data for a thread based on a digital image according to one embodiment.

### DETAILED DESCRIPTION

The system described herein can be used for treatment of a thread that is to be used in a decorative thread pattern. The system could be a system connected to a thread consuming device or a stand-alone treatment system used for treating thread that is to be used at a later stage. The following examples will be directed at a system for in-line treatment of a thread. However, this disclosure is applicable to other kinds of systems as well.

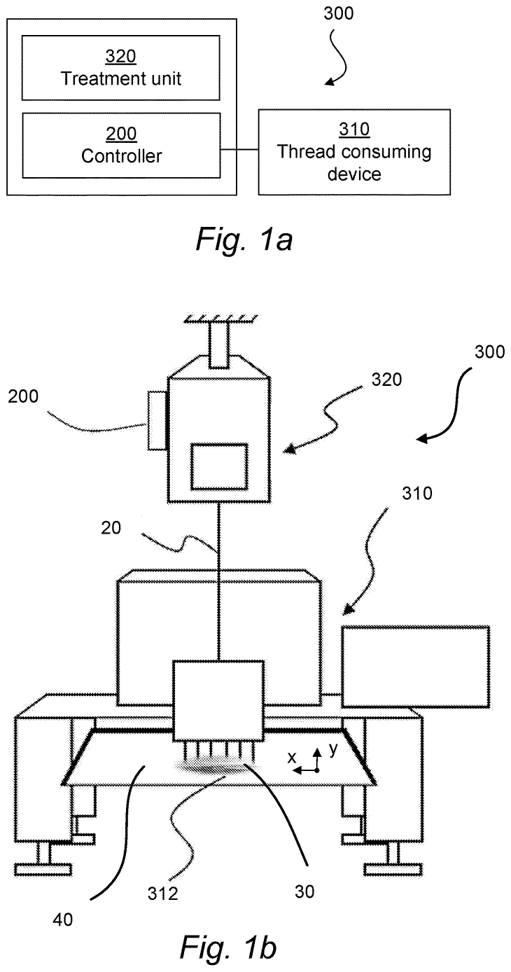

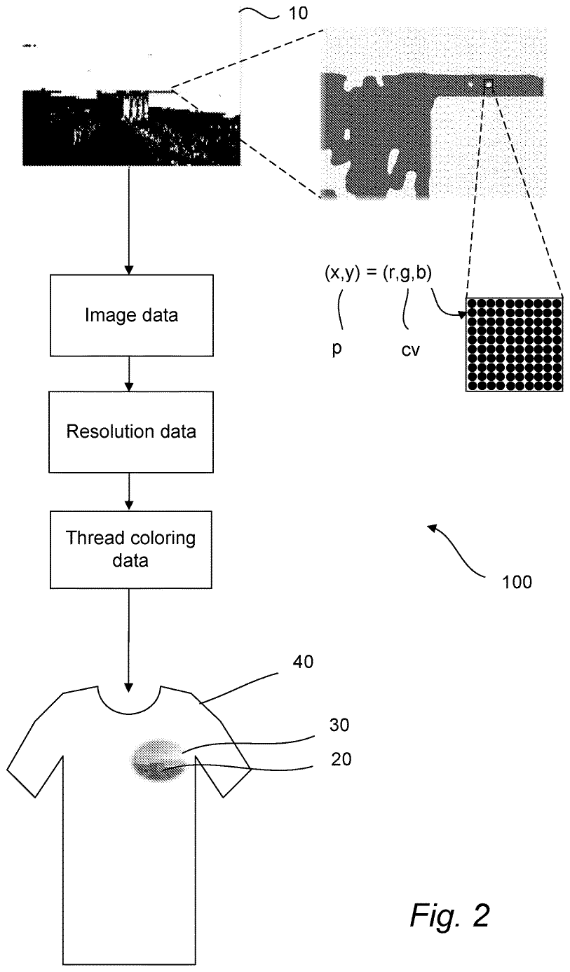

With reference to FIG. 1a, a schematic view of a system 300 for in-line thread coloring is shown. The system 300 comprises a treatment unit 320. The treatment unit 320 may be a coloring unit adapted to dispense one or more coloring substances onto a thread. The treatment unit 320 may comprise one or more discharge devices. Each discharge device comprises a plurality of nozzles, such as for example inkjet nozzles, being configured for dispensing a coloring substance onto the thread 20. The plurality of nozzles may be arranged at different longitudinal positions along the thread 20 which passes by the treatment unit during use. Each discharge device is preferably formed as a series of ink-jet print heads, each print head having one or more nozzle arrays. Each nozzle array typically comprises hundreds or thousands of nozzles.

The system 300 comprises a controller 200, for use with at least one thread consuming device 310. The thread consuming device 310 is in this context any apparatus, which in use consumes thread. It may e.g. be an embroidery machine, weaving machine, sewing machine, knitting machine, a tufting machine, a thread winding machine or any other thread consuming apparatus, which may benefit from in-line thread coloring of an associated thread.

The thread is in this context a flexible elongate member or substrate, being thin in width and height direction, and having a longitudinal extension being significantly greater than the longitudinal extension of any parts of the system described herein, as well as than its width and height dimensions. Typically, a thread may consist of a plurality of plies being bundled or twisted together. The term thread thus includes a yarn, wire, strand, filament, etc. made of various different materials such as glass fibre, wool, cotton, synthetic materials such as polymers, metals, or e.g. a mixture of wool, cotton, polymer, or metal.

The controller 200 is configured for performing different functions related to controlling generation of in-line thread coloring data. The controller 200 may be implemented in any known controller technology, including but not limited to microcontroller, processor (e.g. PLC, CPU, DSP), FPGA, ASIC or any other suitable digital and/or analog circuitry capable of performing the intended functionality.

The controller 200 may be configured to receive digital content. Digital content may be a photography captured by a camera unit, included in or provided external to the system 300. The digital content may alternatively be virtually rendered by the controller 200 or some other type of device capable of rendering digital content.

The controller 200 may be configured to communicate in any known short-range or long-range communication standards known in the art via a communication interface. Short-range communication interfaces include, for instance, IEEE 802.11, IEEE 802.15, ZigBee, WirelessHART, WiFi, Bluetooth®, BLE, RFID, QR, WLAN, MQTT IoT, CoAP, DDS, NFC, AMQP, LoRaWAN, Z-Wave, Sigfox, Thread, EnOcean, mesh communication, or any other form of proximity-based device-to-device radio communication signal such as LTE Direct. Long-range communication interfaces include, for instance, W-CDMA/HSPA, GSM, UTRAN or LTE.

A memory unit (not shown) may be associated with the controller 200, for instance reside therein, and implemented in any known memory technology, including but not limited to E(E)PROM, S(D)RAM or flash memory. The memory unit may alternatively be a cloud storage unit. The cloud storage unit may be deployed as a SQL data model such as MySQL, PostgreSQL or Oracle RDBMS. Alternatively, deployments based on NoSQL data models such as MongoDB, Amazon DynamoDB, Hadoop or Apache Cassandra may be used. Alternatively, the memory unit may reside in an external server configured in any type of client-server or peer-to-peer (P2P) computer architectures. Server configurations may, for instance, involve any combination of e.g. web servers, database servers, email servers, web proxy servers, DNS servers, FTP servers, file servers, DHCP servers, to name a few.

In some embodiments, the memory unit may be integrated with or internal to the controller 200. The memory unit may store program instructions for execution by the controller 200, as well as temporary and permanent data used by the controller 200. Program instructions and/or temporary and permanent data pertain to the in-line thread coloring data as well as other data used by the controller 200 to generate said in-line thread coloring data. The stored in-line thread coloring data may be used for coloring a thread either directly (with at least some expected delay as is readily understood by the person skilled in the arts of computer networking), or at a later stage.

The stored in-line thread coloring data may be transmitted and used in one or more other systems 300. Accordingly, the in-line thread coloring data generated in the controller 200 is not necessarily used in the same system 300 that comprises said controller 200. In this sense, the in-line thread coloring data may be stored as a computer program product in a computer-readable medium.

Now turning to FIG. 1b, wherein an exemplary embodiment of the system 300 for in-line thread coloring is shown. The system 300 comprises the thread consuming device 310, which in this example is embodied as an embroidery machine, and more specifically a single-head embroidery machine. The system 300 further comprises the treatment unit 320 and the controller 200. The controller 200 is not limited to being arranged according to FIG. 1b. In alternative embodiments, the controller 200 may be arranged anywhere in or external to the system 300. The thread consuming device 310 comprises a moveable stage 312 carrying a fabric 40, or practically any type of substrate. The thread 20 is to be embroidered on the fabric 40 such that an embroidery pattern 30 is created thereon. The embroidery pattern 30 may have any size, shape, form, dimensions, pattern, figure, shape, text, emblem, symbol, or the like. The embroidery pattern 30 may e.g. be an embroidered logotype or a company name. The controller 200 may be configured to determine the above mentioned information related to the embroidery pattern 30. During operation, the moveable stage 312 is controlled to change its position in the X and Y direction (i.e. the horizontal plane).

The treatment unit 320 allows the thread consuming device 310 to operate without the provision of uniquely pre-colored threads, as is required for conventional embroidery machines. Accordingly, the treatment unit 320 provides in-line thread coloring of the thread 20 in accordance with predetermined coloring data, such that the colored embroidery pattern 30 can be produced. The treatment unit 320 thus replaces individual thread reels as is present in prior art systems not using in-line thread coloring. The process of generating in-line thread coloring data for the thread 20 is orchestrated by the controller 200.

It should be understood by a person skilled in the art that the use of an embroidery machine to create an embroidery pattern 30 is merely one example. The digital representation to be produced can be seen as a thread arrangement comprising a plurality of consecutive thread portions, where the wherein the entire thread arrangement corresponds to the digital representation to be produced. The pattern 30 to be produced is produced by arranging thread portions in a production path so as to generate a decorative thread pattern.

In one embodiment, the decorative thread pattern is an embroidery, the thread arrangement 22 is a stitch pattern, and the plurality of consecutive thread portions 24 is a plurality of consecutive stitches. In one embodiment, the decorative thread pattern is a knitted fabric and the thread arrangement 22 is a stitch pattern, and the plurality of consecutive thread portions 24 is a plurality of consecutive stitches. In one embodiment the decorative thread pattern is a sewn fabric, the thread arrangement 22 is a stitch pattern, and the plurality of consecutive thread portions 24 is a plurality of consecutive stitches.

In one embodiment, the decorative thread pattern is a woven fabric and the thread arrangement 22 is a weave pattern, and the plurality of consecutive thread portions 24 is a plurality of consecutive interlacing between a warp and a weft.

In one embodiment, the decorative thread pattern is a tufted fabric and the thread arrangement 22 is a tuft pattern, and the plurality of consecutive thread portions 24 is a plurality of consecutive tuft piles.

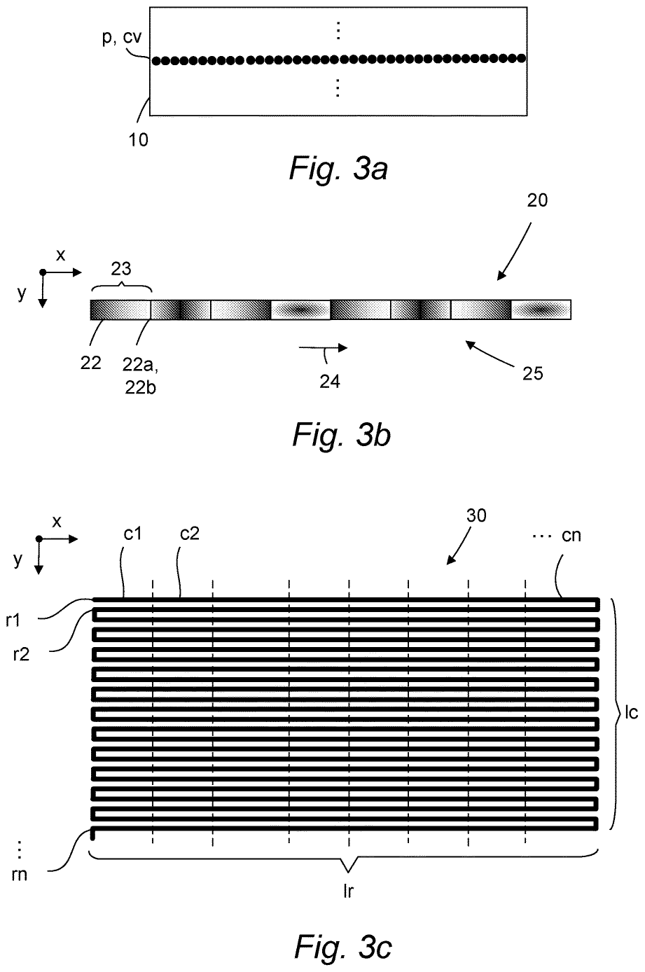

FIG. 2 is a schematic illustration of a method 100 for generating thread coloring data for a thread 20 based digital content according to one embodiment. The digital content may be a (2D) digital representation 10. The in-line colored thread 20 is in this example stitched onto a fabric 40 (depicted as a shirt) for embroidering an embroidery pattern 30, however this should merely be seen as one example of application. The digital representation 10 is in this example a digital image which may be represented in a bitmap graphics format including but not being limited to GIF, JPEG, PNG, TIFF, XBM, BMP, PCX, or similar. As previously discussed with reference to FIGS. 1a-b, the thread coloring data may alternatively be stored for future use in the same or another system. In the following the term digital image will be used, however it should be noted that the concept described is applicable to the broader term digital representation as well.

The method 100 may involve receiving the digital representation 10, for instance via a camera unit or similar, as discussed with reference to FIGS. 1a-b.

The method 100 may further involve obtaining pattern data from the received digital representation 10. Pattern data comprises information related to pixels in the digital representation 10. Accordingly, the pattern data comprises a plurality of pixels, wherein each pixel is associated with a position p in the digital image 10 and a color value cv. In the example where the digital representation 10 is a digital image, the pattern data may be seen as the image data.

Since the digital representation 10 is two-dimensional, the position p is indicative of a two-dimensional position. As an example, a pixel located at a top left corner of the digital image 10 may have a position p=(0, 0), and a pixel located at the bottom right corner of the digital image 10 may have a position p=(rowₘₐₓ, colₘₐₓ), wherein rowₘₐₓ is the maximum number of pixel rows in the digital image 10 and colₘₐₓ is the maximum number of pixel columns in the digital image 10. In this example, if the resolution of the digital representation is 1080p (1920×1080), the pixel located at the bottom right corner of the digital image 10 has the position p=(1080, 1920). Similar pixel positions can be realized for other image resolutions, e.g. 2K, 4K, 8K and so forth.

For reasons of brevity, the digital representation 10 is in this disclosure referred to as being generally square or rectangular in shape. However, the skilled person will appreciate that this is purely by way of some examples. In other examples, the digital representation 10 may be associated with any suitable shape, such as circles, ovals, triangles, pentagons, hexagons, octagons, diamonds, trapezoids, parallelograms, stars, crescents, crosses, arrows, or practically any substantially regular or irregular shape known that may be represented by a digital representation 10.

To this end, it shall be understood that the terms “rows” and “columns” as used herein may be rows and columns in view of any of these other exemplary shapes. To this end, the terms “row” and “column” are not necessarily to be interpreted as horizontally or vertically straight in the context of, for example, matrices. This is especially the case concerning non-square or non-rectangular shapes, such as circles. It should therefore be understood that the terms “row” and “column” as used in this disclosure refer to the relative arrangement of elements rather than the physical straightness of a line, i.e., one stitch or pixel after the other. In contexts of the present disclosure, the rows and columns are sequences of elements organized in a specific order. By way of example, a substantially circular pattern may include a plurality of substantially circumferential rows or columns, while a substantially square pattern may include a plurality of substantially straight rows or columns.

The color value cv may pertain to any color space known in the art, e.g. the RGB or CMYK color space. Accordingly, if the color value cv of a pixel in the RGB color space is derived as (0, 0, 0), the color value cv represents the color black.

After having obtained the pattern data of the digital representation 10, the method 100 further involves generating resolution data. Resolution data is generated by processing the pattern data of the digital representation. During this procedure, information relating to a thread arrangement comprising a plurality of consecutive thread portions of the pattern 30 to be created/produced is determined. The processing of the pattern data may comprise determining information relating to the length 23 of the thread portions, the direction 24 of the thread portions, and/or the type 25 of connections used for consecutive thread portions.

In one embodiment, the pattern data comprises a plurality of stiches that are to be embroidered. The information relating to the thread arrangement comprising a plurality of consecutive thread portions can thus be seen as information relating to the stiches, or stich data. The processing step may then include deriving stitch data for a plurality of interconnecting stitches 22, the stitch data comprising a stitch length 23, a stitching direction 24 and a stitch type 25.

The method 100 further comprises generating thread coloring data for the thread 20 at least based on the resolution data. The thread coloring data is either stored in, for instance, the memory unit of the controller as described with reference to FIGS. 1a-b, or used directly to create the pattern 30.

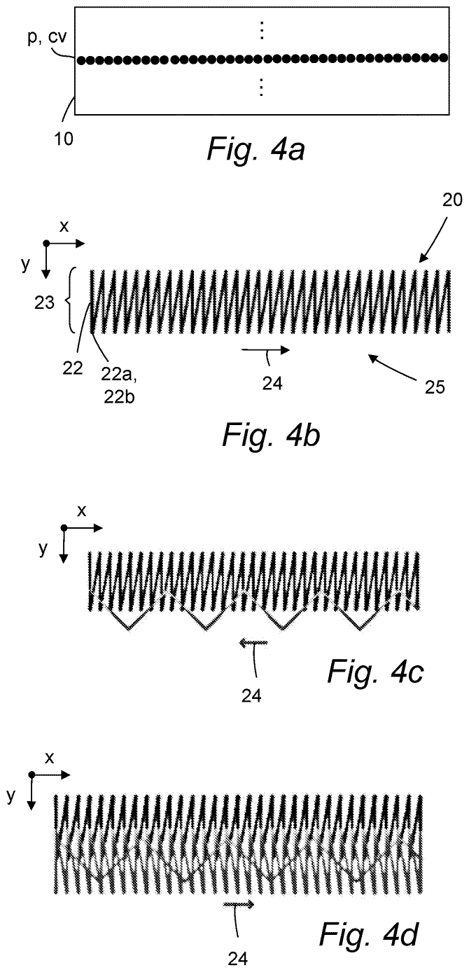

Further details related to the generation of resolution data and the information relating to the plurality of consecutive thread portions will now be described according to two different embodiments, shown in FIGS. 3a-c and 4a-e, respectively. In the following examples, the steps of determining information relating the consecutive thread portions (such as relating to the length 23 of the thread portions, the direction 24 of the thread portions and the type 25 of connections used for consecutive thread portions) will be referred to as stich data for easier reference. However, it should be understood by a person skilled in the art that the thread coloring data for a thread could be produced for other types of creations other than stiches.

In FIGS. 3a-c and 4a-e, embodiments of generating resolution data are shown. FIGS. 3a-c and 4a-e illustrate how stitch data is derived from a plurality of pixel portions, wherein each pixel portion comprises a plurality of pixels each having a position p and a color value cv. As is readily understood by the skilled person, a pixel portion may be a column, a row, a portion of a row or a portion of a column of the digital image 10. A pixel portion may alternatively be interpreted as an axis, such as a generally horizontal axis (x) or a generally vertical axis (y). The resolution data disclosed herein is, therefore, not restricted to a stitching direction. This essentially means that the pattern 30 being based on the digital image 10 can be stitched from either direction given that an accurate reproduction of said digital image 10 can be represented in the pattern 30.

Processing the pattern data involves deriving stitch data for a plurality of interconnecting stitches 22. The term “interconnecting” may be interpreted as being able to provide a pattern 30 based on the digital image 10 using a single thread 20, since the stitches provided by the thread 20 are interconnected. Alternatively put, deriving stitch data for a plurality of interconnecting stitches 22 does not require changing of thread reels comprising differently colored threads. This furthermore involves that each subsequent stitch 22 is being stitched from a starting position 22a that corresponds to the end position 22b of the previous stitch 22. Accordingly, the process of stitching the pattern 30 does not require abrupt stops and/or changes in needle placement position due to the digital image 10 having changes in color. The resolution data accordingly comprises information for each subsequent and interconnected stitch 22.

In both of the embodiments shown in FIGS. 3a-c and 4a-e, the stitch data at least comprises a stitch length 23, a stitching direction 24 and a stitch type 25.

The stitching direction 24 may be arbitrarily chosen. Alternatively, the stitching direction may depend on either one or a combination of type of motive in the digital image 10, the level of detail in the digital image 10. the fabric to receive the pattern 30, or any other appropriate factor. In another embodiment, determining the stitching direction 24 may be performed by calculating a weighted direction value based on two or more of the above-mentioned factors.

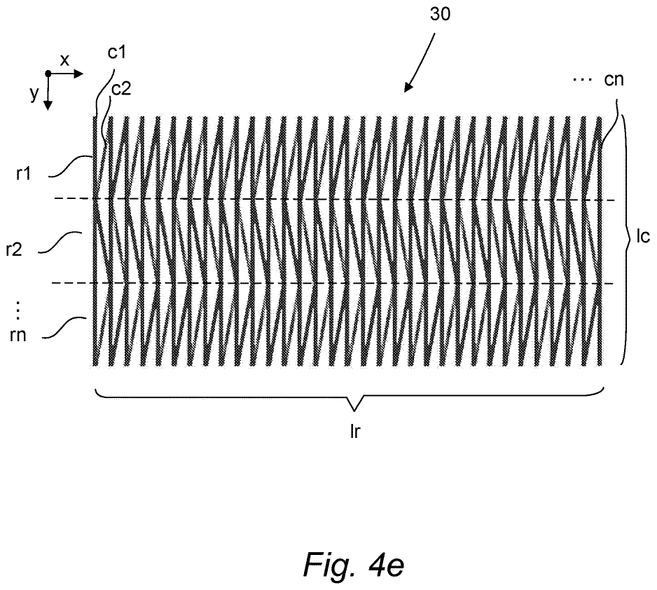

The stitch type 25 is in FIGS. 3b-c straight stitches and in FIG. 4b-e satin stitches. The stitch type 25 is however not restricted to these stitches. The stitch type 25 may alternatively be selected from a group comprising straight stitches or reverse straight stitches, satin stitches or reverse satin stitches, tacking stitches, backstitches, catch stitches, slip stitches, blanket stitches, fell stitches, overcast stitches, whip stitches, stem stitches, split stitches, French knot stitches, chain stitches, feather stitches, lazy daisy stitches, herringbone stitches, seed stitches, fly stitches, detached chain stitches, couching stitches, woven wheel stitches, bullion stitches, zigzag stitches, stretch stitches, edge stitches, rolled edge stitches, triple straight stitches, cover stitches, buttonhole stitches, blind hem stitches, scallop stitches, shell tuck stitches, overcasting stitches, insertion stitches, ladder stitches, multi-step zigzag stitches, overlock stitches, lock stitches and decorative stitches.

The stitch length 23 depends on the stitch type 25. The present inventors have conducted experiments to determine the shortest possible length 23 for each stitch 22. Accordingly, the stitch length 23 is derived as a fixed value depending on the shortest possible stitch length 23 that can viably be colored with one coloring substance. The shorter the stitch length 23 that can be colored in one specific color, the higher the resolution of the pattern 30 will be. However, due to a plurality of operational reasons such as e.g. accuracy of the coloring substance application, rotation of thread, speed of thread, smearing of coloring substances, and other physical factors, the length of stitch 22 colored in one specific color clearly cannot be indefinitely short. Moreover, when the stitch length 23 is sufficiently short, the human eyes will not perceive changes in color.

In alternative embodiments, the stitch data may comprise additional stitch data including information related to operational statuses, such as speed of the thread consuming unit and/or other signal(s), material(s) of thread and/or fabric, movement of the movable stage 312, maintenance of components, and so forth.

Attention is now given to FIGS. 3b-c, wherein straight stitches are shown. The present inventors have determined the optimal stitch length 23 of the thread 20 with respect to the above discussion as approximately 1.50 mm. This value may vary slightly depending on e.g. material of the thread and/or fabric. The stitch length 23 of straight stitches may therefore vary between approximately 1.40 mm and 1.60 mm. However, depending on the digital image 10, the stitch length is not necessarily the shortest possible stitch length 23. For instance, the stitch length 23 may be longer for some digital images 10 not having as advanced color depth. Hence, the stitch length 23 may depend on the motive of the digital image 10.

The generation of resolution data for straight stitches will now be discussed in detail with reference to FIGS. 3a-c. It shall be noted that, although the exemplary resolution data generation schemes as will be discussed with reference to FIGS. 3a-c refer to a digital representation 10 of a substantially rectangular shape, other shapes may be realized, as discussed above. Correspondingly, the rows and columns as discussed with reference to FIG. 3a-c are substantially straight, although this is merely for exemplary purposes.

The resolution generation comprises selecting a first pixel among the plurality of pixels. This is shown in FIG. 3a. The first pixel may be selected as a pixel having its position p at one end point of a pixel portion, e.g. p(x, y)=(nbr_{row}, 0), (nbr_{row}, colₘₐₓ), (0, nbr_{col}), or (rowₘₐₓ, nbr_{col}), wherein nbr_{row} and nbr_{col} is an arbitrary column or row number, respectively, in the digital image 10. Similar end point positions of pixel portions may be realized for portions of rows or portions of columns. Alternatively, the starting position may be any arbitrarily selected starting position p of a pixel in the digital image 10 based on e.g. its motive and/or level of detail.

The position of the first pixel together with the stitching direction 24 represents a first pixel portion x, as seen in FIG. 3b. In the direction of the first pixel portion x, a plurality of rows are defined in parallel with one another. This is seen in FIG. 3c, wherein the rows are denoted r1, r2, . . . , rn, wherein n is the number of rows.

In FIG. 3c, generating the resolution data further comprises calculating a first resolution as a maximum number of stitches 22 fitting a corresponding row r1-n. The first resolution can thus be interpreted as a density of stitches in the “x” direction, i.e. the length of the row lr. The first resolution may be derived by calculating the length of the row lr and the number of stitch lengths fitting the length of the row lr. As an example, if the length of the row lr is calculated as 30.0 cm (300.0 mm), and the stitch length is 1.50 mm, the number of stitches fitting said row will in this example be calculated according to

$$r e s ( x ) = \frac{{l}_{r}}{{l}_{s}} = \frac{300}{1.5} = 200.$$

Accordingly, 200 stitches fit the length of the corresponding row.

Generating the resolution data further comprises calculating a second resolution as a maximum number of stitches fitting a column c1-n being substantially perpendicular to a corresponding row. The term “substantially perpendicular” refer to the concept of the relative arrangement of elements rather than the physical straightness of a line, as discussed above. To this end, it shall be understood that the sequence of elements organized according to the column is substantially perpendicular to the sequence of elements organized in according to the row. In some examples, the column is perpendicular to the corresponding row. The second resolution can thus be interpreted as a density of stitches in the “y” direction. Similar to the first resolution, the number of stitches fitting a column will in this example be calculated according to

$$r e s ( y ) = \frac{{l}_{c}}{{l}_{s}} ,$$

wherein lc is the length of the corresponding column. However, there is a significant different in how the stitch length ls is interpreted when calculating the second resolution. This is because the thread is very thin, thereby making it possible to embroider each row very close to each other in the pattern 30 such that stitches 22 in subsequent rows align with stitches 22 in the corresponding previous row. For straight stitches, the second resolution res(y) is higher than the first resolution res(x). This difference can be directly derived from FIG. 3c, wherein it is seen that the ratio between stitches 22 fitting a column length lc is higher than the ratio between stitches 22 fitting a row length lr. Only 8 stitches 22 fit each row length lr (c1 to cn=8), wherein 24 stitches 22 fit each column length lc (r1 to m=24), i.e. three times as many. Although the figure is to be interpreted as a mere diagrammatical representation, the row length lr is clearly not three times as long as the column length lc.

The resolution data is defined by the first and second resolutions res(x), res(y), i.e. the density of stitches 22 in the “x” and “y” directions, respectively. “Defined by” may in this sense be interpreted as a multiplicative relationship. Hence, the resolution res(e) is calculated according to res(e)=res(x)*res(y). Although the motive of the digital image may vary, the second resolution res(y) will be higher than the first resolution res(x).

Attention is now given to FIGS. 4b-e, wherein satin stitches are shown. The present inventors have determined the optimal stitch length 23 of the thread 20 with respect to the above discussion as approximately 3.0 mm. The stitch length 23 for satin stitches were determined based on the following formula: lₛ=sₚ(nₒ−1)+sₒ, lₛ being the stitch length 23, sₚ being a pixel size, nₒ being a number of overlapping rows, and sₒ being a minimum overlap size. This value may vary slightly depending on e.g. material of the thread 20 and/or fabric to receive the pattern. The stitch length 23 of satin stitches may therefore vary between approximately 2.80 mm and 3.20 mm. However, depending on the digital image 10, the stitch length is not necessarily the shortest possible stitch length 23. For instance, the stitch length 23 may be longer for some digital images 10 not having as advanced color depth. Hence, the stitch length 23 may depend on the motive of the digital image 10.

The generation of resolution data for satin stitches will now be discussed in detail with reference to FIGS. 4a-e. It shall be noted that, although the exemplary resolution data generation schemes as will be discussed with reference to FIGS. 4a-c refer to a digital representation 10 of a substantially rectangular shape, other shapes may be realized, as discussed above. Correspondingly, the rows and columns as discussed with reference to FIG. 4a-c are substantially straight, although this is merely for exemplary purposes. The resolution generation comprises selecting a first pixel among the plurality of pixels. This is shown in FIG. 4a. The first pixel may be selected similar to how the first pixel was selected for straight stitches, as discussed with reference to FIG. 3a.

The position of the first pixel together with the stitching direction 24 represents a first pixel portion x, as seen in FIG. 4b. FIGS. 4c-d further illustrates how satin stitches are being made. Constructing satin stitches is, per se, known in the art and will, therefore, not be described any further herein. In the direction of the first pixel portion x, a plurality of rows are defined in parallel with one another. This is seen in FIG. 4e, wherein the rows are denoted r1, r2, . . . , m.

With reference to FIG. 4e, generating the resolution data further comprises calculating a first resolution as a maximum number of stitches 22 fitting a column being substantially perpendicular to a corresponding row r1-n. The term “substantially perpendicular” refer to the concept of the relative arrangement of elements rather than the physical straightness of a line, as discussed above. To this end, it shall be understood that the sequence of elements organized according to the column is substantially perpendicular to the sequence of elements organized in according to the row. In some examples, the column is perpendicular to the corresponding row. The columns are denoted c1, c2, . . . , cn. The first resolution can thus be interpreted as a density of stitches in the “y” direction. The first resolution may be derived by calculating the length of the column lc and the number of stitch lengths fitting the length of the column lc. As an example, if the length of the column lc is calculated as 30.0 cm (300.0 mm), and the stitch length is 3.0 mm, the number of stitches fitting a row will in this example be calculated according to

$$r e s ( y ) = \frac{{l}_{c}}{{l}_{s}} = \frac{300}{3.} = 100 .$$

Accordingly, 100 stitches fit the length of the corresponding column.

Generating the resolution data further comprises calculating a second resolution as a maximum number of stitches 22 fitting a corresponding row r1-n. The second resolution can be interpreted as a density of stitches in the “x” direction. Similar to the first resolution, the number of stitches fitting a row will in this example be calculated according to res(x)=lᵣ/lₛ, wherein lr is the length of the corresponding row. However, similar to the calculation of the second resolution in the straight stitches example with reference to FIG. 3c, there is a significant different in how the stitch length ls is interpreted when calculating the second resolution. In the case of satin stitches, it is the opposite to straight stitches. Since the thread is very thin, it is possible to embroider each column (as opposed to row straight stitches) very close to each other in the pattern 30 such that the thread color in subsequent columns align with the previous one. For satin stitches, the second resolution res(x) is higher than the first resolution res(y). This difference can be directly derived from FIG. 4e, wherein it is seen that the ratio between stitches 22 fitting a row length lr is higher than the ratio between stitches 22 fitting a column length lc. Only 3 stitches 22 fit each column length lc (r1 to rn=3), wherein 65 stitches 22 fit the row length lr (c1 to cn=65), i.e. almost 22 times as many.

The resolution data is defined by the first and second resolutions res(x), res(y), i.e. the density of stitches 22 in the “x” and “y” directions, respectively. “Defined by” may be interpreted as a multiplicative relationship. Hence, the resolution res(e) may be calculated according to res(e)=res(x)*res(y). Although the motive of the digital image may vary, the second resolution res(x) will be higher than the first resolution res(y).

After the resolution data has been calculated, e.g. according to subject-matter described with reference to FIGS. 3a-c or 4a-e, or alternatively for any of the other stitch types as discussed herein, portions of the stitches to be embroidered may be grouped. Accordingly, the method 100 may further involve grouping stitches according to the calculated resolution data. Grouping of stitches to be embroidered may be useful for certain digital images having a varied level of detail. For instance, the digital image 10 seen in FIGS. 1b and 2 is seen to have a generally higher level of detail in the center and lower portions of the image 10 wherein a castle and a forest are illustrated. In the upper portions of the image 10 wherein a sky and some clouds are illustrated, the level of detail is significantly lower. Portions of the digital image 10 representing a lower level of detail may accordingly have a lower resolution data, due to a lower number of stitches representing a higher number of pixels. As a consequence of the grouping of stitches, the perceived quality of the pattern 30 will remain the same while a fewer number of stitches are required, thus effectively reducing the complexity of the generation of the resolution data.

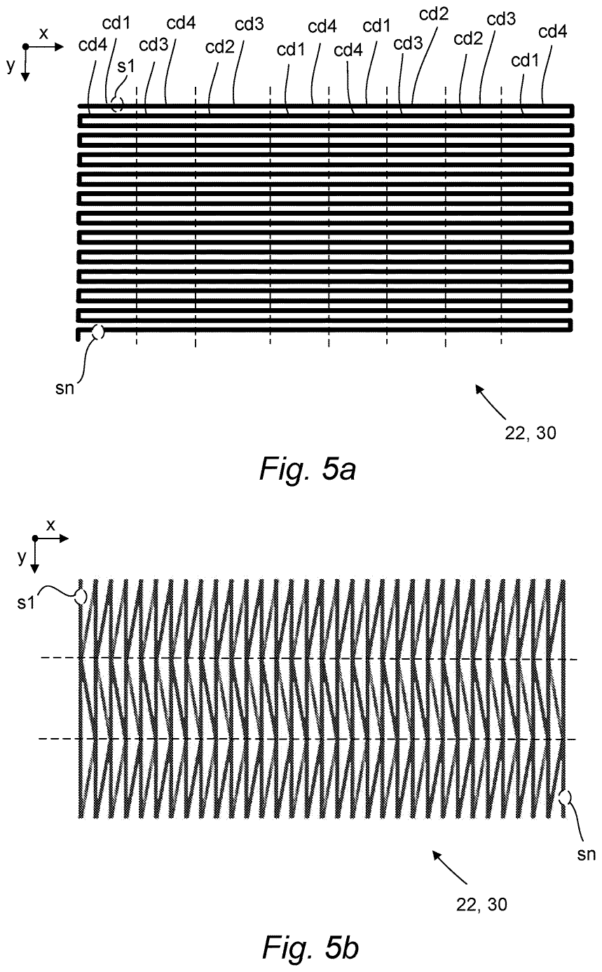

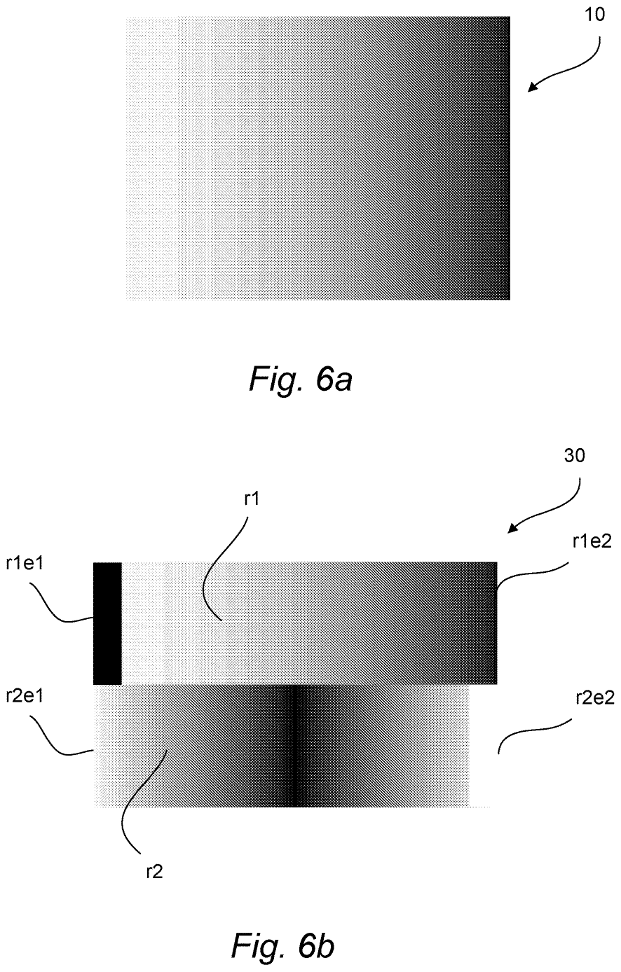

With reference to FIGS. 5a-b, generating in-line thread coloring data for the thread 20 at least based on the resolution data is shown.

Generating in-line thread coloring data may comprise transforming the color values cv of the pixels in the digital image 10 as illustrated in FIGS. 4a and 5a to the calculated resolution data, and extracting (obtaining, retrieving, etc.) color data from said transformed color values in order of a production path as defined by the plurality of interconnecting stitches 22.

Transforming the color values cv of the pixels in the digital image 10 to the resolution data may be performed by constructing an updated bitmap of the digital image 10, and providing the resolution data as input parameters to the creation of the bitmap. The bitmap is typically represented in the same format as the digital image 10, as described earlier in this disclosure. The resulting bitmap thus comprises the transformed color values according to the calculated resolution data. Accordingly, the transform involves obtaining the color data of the stitches to be embroidered such that they correspond to the color values cv of the pixels.

Extracting the color data from said transformed color values in order of a production path may be performed by, for each pixel in the updated bitmap of the digital image 10, retrieving a color data cd representation for the transformed color value of said each pixel. The color data cd may be color values in e.g. the RGB or CMYK color space, as discussed earlier for the color values cv. Hence, this procedure involves retrieving the color data cd of the transformed color values in the updated bitmap of the digital image 10, wherein the updated bitmap is generated according to resolution data.

FIGS. 5a-b show two embodiments of in-line thread coloring data generation. FIG. 5a corresponds to the in-line thread coloring data generation for straight stitches, and FIG. 5b corresponds to the same for satin stitches. It shall be noted that, although the exemplary in-line thread coloring data generation schemes as will be discussed with reference to FIGS. 5a-b refer to a digital representation 10 of a substantially rectangular shape, other shapes may be realized, as discussed above. Correspondingly, the rows and columns as discussed with reference to FIG. 5a-b are substantially straight, although this is merely for exemplary purposes. In the illustration shown in FIG. 5a, it can be seen that each stitch 22 is associated with color data cd1-4. Although not explicitly shown, a similar color data representation can be realized for the illustration shown in FIG. 5b as well. The color data representation cd1-4 is extracted in the order of the production path as defined by the plurality of interconnecting stitches 22. The production path comprises a first stitch s1, followed by a plurality of subsequent stitches 22, and a final stitch sn. Each one of the stitches s1, 22, sn are interconnected according to the two examples shown. Further examples can be realized for alternative digital images 10, patterns 30 and/or stitch types. Hence, for each interconnecting stitch 22 in the production path, a color data cd1-4 is extracted.

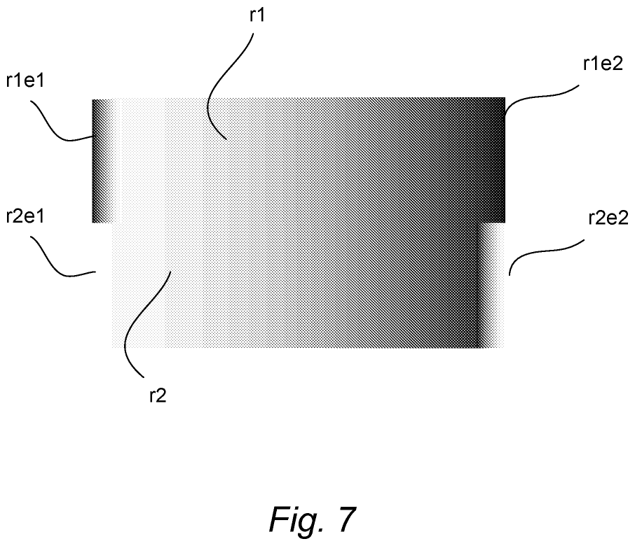

With reference to FIGS. 6a-b, 7 and 8a-d, different embodiments of generating transitional colors for underlay stitches are shown. Underlay stitches have at least two functions in the creation of in-line thread coloring data for a thread 20. The first function is to act as transportation between the end position of a first stitch and a start position of a subsequent stitch. The second function is to hide errors in edges of the pattern to be produced caused by varying levels of thread consumption in the thread consumption machine. Coloring the underlay stitches can, therefore, provide a more consistent and accurate transition between a first edge and a second edge of the embroidery pattern.

FIGS. 6a-b illustrate a problem that may arise for some digital images 10 when it is being converted into in-line thread coloring data for an embroidery pattern 30 and satin stitches are used in said embroidery pattern 30. The illustration shows a portion of the digital image 10 being converted into in-line thread coloring data for two embroidery rows r1, r2, but the general idea applies for the entire digital image/embroidery pattern 10/30. FIG. 6a represents the portion of the digital image 10, and FIG. 6b represents the in-line thread coloring data for the embroidery pattern 30 being based on the portion of the digital image 10. In FIG. 6b, in-line thread coloring data has not been determined for underlay stitches. As seen in the illustration, the color data representation of edge portion r1e1 is not accurately reproduced. The problem is caused by the abrupt change in color values when the production path is traveling from the upper right edge r1e2 to the upper left edge r1e1 via underlay stitches (e.g. as seen in FIG. 4c). The variation in thread consumption has caused the upper left edge r1e1 to assume a similar color data representation as the upper right edge r1e2. Alternatively put, the varying thread consumption causes the color transformation in the first row r1 to be delayed such that the upper left edge r1e1 receives a similar color representation as the upper right edge r1e2. Furthermore, the opposite has occurred for the edges r2e1 and r2e2. Generating transitional colors for the underlay stitches can solve the errors in color data representation as shown in FIG. 6b.

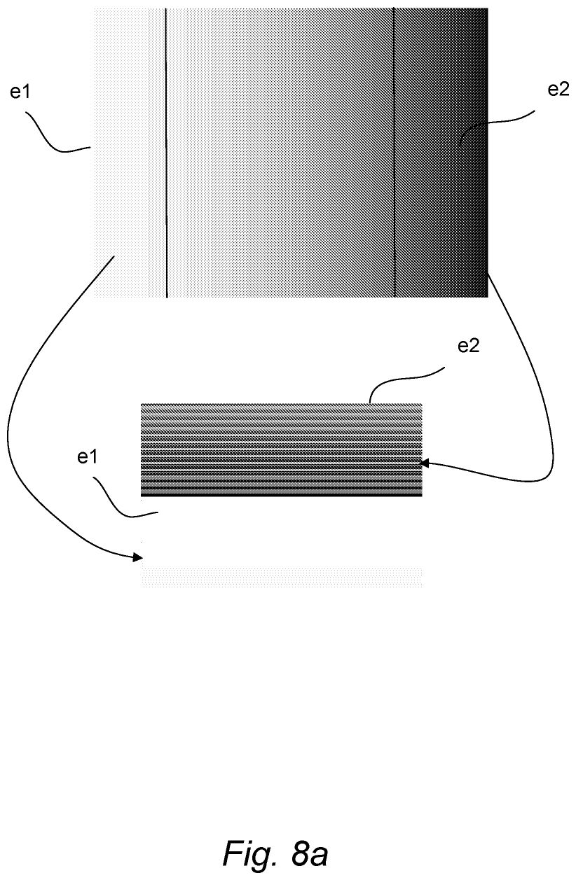

With reference to FIG. 7, in-line thread coloring data for an embroidery pattern is shown, wherein transitional colors have been generated for underlay stitches according to one embodiment. In the shown embodiment, a color gradient has been generated comprising the color data of the upper left edge r1e1 ranging to the color data of the lower right edge r2e2. Accordingly, the abrupt change in color data as depicted in FIG. 6b is at least partly mitigated.

The procedure involves retrieving color data from a first edge portion r1e1 defined by the in-line thread coloring data, wherein the first edge portion r1e1 corresponds to a first embroidery row r1. The color data is comprised in the in-line thread coloring data for each of the stitches to be embroidered. The procedure similarly involves retrieving color data from a second edge portion r2e2, wherein the second edge portion r2e2 is opposite from the first edge portion r1e1 and selected from an embroidery row r2 subsequent and parallel to the first embroidery row r1. “Opposite” refers to the other end of an embroidery row defined by the in-line thread coloring data.

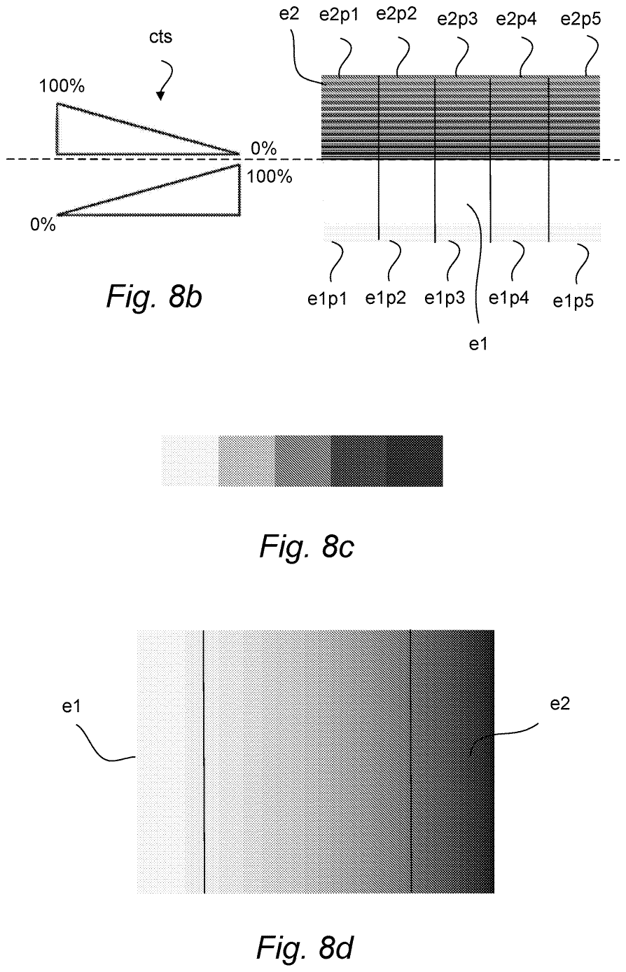

The procedure further involves generating a color gradient comprising a combination of the color data of the first edge portion r1e1 and the second edge portion r2e2, and replacing the color data in original edge portions r1e1, r2e2 with the color data of the color gradient. For simplification purposes, FIG. 7 only shows two rows r1, r2. Although not explicitly shown, the procedure further involves, for each subsequent pair of edge portions defined by the in-line thread coloring data, repeating the procedure of retrieving color data from edge portions, generating a color gradient comprising a combination of said retrieved color data, and replacing the color data of the edge portions with the color gradient. This type of gradient may be suitable for some digital images 10 wherein the level of detail is not too high. However, for some other digital images 10, the present inventors described a further improved procedure. This will now be described with reference to FIGS. 8a-e, wherein another type of gradient is shown.

In FIGS. 8a-e, in-line thread coloring data for an embroidery pattern is shown, wherein transitional colors have been generated for underlay stitches according to one embodiment.

In FIG. 8a, color data are retrieved from a first and second edge e1, e2, respectively, as defined by the in-line thread coloring data. Compared to the embodiment as described with reference to FIG. 7, this procedure involves retrieving color data from edges e1, e2 of the entire embroidery pattern to be embroidered as defined by the in-line thread coloring data, i.e. not just a pair of rows (edge portions). Subsequently, a color gradient is generated comprising a combination of the color data of the first and second edge e1, e2.

In one embodiment illustrated in FIG. 8b, generating the color gradient may be performed by aligning the first and second edges e1, e2 in parallel and subsequent to one another. Hence, the first and second edges e1, e2 are interpreted as embroidery rows as defined by the in-line thread coloring data, the first row being e2 in the illustration and the second row being e1. The embodiment further involves partitioning the aligned edges e1, e2 into a plurality of portions e1p1-n, e2p1-n, wherein n is the number of portions. In the shown example, n=5, but the edges e1, e2 may be partitioned into any number of portions p1-n. Alternatively, the edges e1, e2 may have a varied number of edges such that, for instance, two or more portions of the first edge e1 are aligned with a single portion of the second edge e2.

The embodiment further involves combining the color data of the respective portions e1p1-5, e2p1-5 according to a color transitioning scheme cts. An example of a color transitioning scheme cts is illustrated in FIG. 8b. It is shown that the aligned portions may be combined by combining 100% of the color data of the portion e2p1 with 0% of the color data of the portion e1p1. Accordingly, the color data of the portion e2p1 will be dominant in the combined color data. Moreover, the color transitioning scheme cts descends from 100% to 0% for the second edge e2, and at the same time ascends from 0% to 100% for the first edge e1. The result is that the combined portions will have a varying range of color data from the portions e1p1-5 of the first edge e1 and from the portions e2p1-5 of the second edge e2.

The color transitioning scheme cts is not limited to the scheme shown in FIG. 8b (i.e. 100% to 0% and 0% to 100%, respectively). The color transitioning scheme cts may have any suitable percentage-based distribution, e.g. 20% to 80% and 80% to 20%, respectively, 40% to 100% and 80% to 0%, respectively, or any other distribution such that the sum of the color contributions for each pair of portions adds up to 100%. The difference in color transitioning schemes cts may depend on e.g. the level of detail or resolution of the digital image being converted into an embroidery pattern.

FIG. 8c shows the color gradient generated from the procedure as described above with reference to FIG. 8b.

In FIG. 8d, the color data in the color gradient has replaced the original color data from the edges e1, e2, thereby effectively mitigating the color errors as e.g. caused by inherent changes in thread consumption.

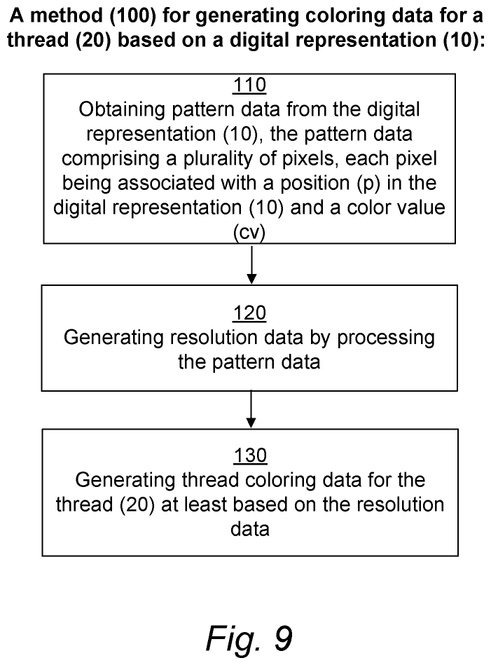

FIG. 9 illustrates a method 100 for generating in-line coloring data for a thread 20 based on a digital image 10 according to one embodiment. The method 100 comprises a step 110 of obtaining pattern data from the digital image 10, wherein the pattern data comprises a plurality of pixels, each pixel being associated with a position p in the digital image 10 and a color value cv. The method further comprises a step 120 of generating resolution data by processing the pattern data. The method further comprises a step 130 of generating in-line thread coloring data for the thread 20 at least based on the resolution data.

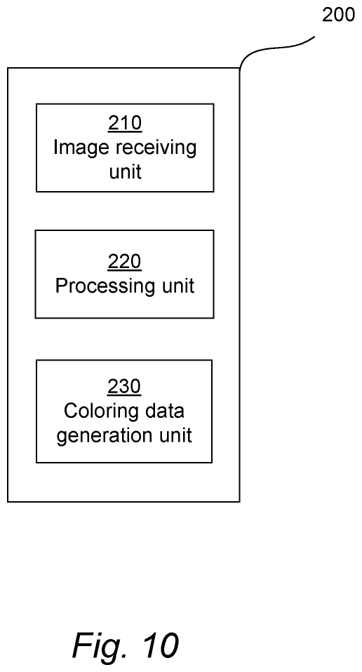

FIG. 10 illustrates a controller 200 according to one embodiment. The controller 200 may be the controller 200 as described with reference to FIGS. 1a-b. The controller is configured to implement the method 100. The controller 200 may comprise an image receiving unit 210 configured to receive the digital image 10 and obtain pattern data thereof. The controller 200 may comprise a processing unit 220 configured to process the pattern data to generate resolution data. The controller 200 may comprise a coloring data generation unit 230 configured to generate in-line coloring data for a thread based on at least the resolution data.

In one embodiment, generating the resolution data further comprises selecting a first pixel among the plurality of pixels, wherein the position of the first pixel and the production path direction represents a first axis, wherein a plurality of rows is defined in parallel with one another in the direction of the first axis, calculating a first resolution as a maximum number of connections fitting a corresponding row, and calculating a second resolution as a maximum number of connections fitting a column being perpendicular to a corresponding row, wherein the resolution data is defined by the first and second resolutions.

In one embodiment, generating the resolution data further comprises selecting a first pixel among the plurality of pixels, wherein the position of the first pixel and the production path direction represents a first axis, wherein a plurality of rows is defined in parallel with one another in the direction of the first axis, calculating a first resolution as a maximum number of connections fitting a column being perpendicular to a corresponding row, and calculating a second resolution as a maximum number of connections fitting a corresponding row, wherein the resolution data is defined by the first and second resolutions.

In one embodiment, a method for generating in-line thread coloring data for a thread based on a digital image is provided. The method comprises obtaining image data from the digital image, the image data comprising a plurality of pixels, each pixel being associated with a position in the digital image and a color value, generating embroidery resolution data by processing the image data, and generating in-line thread coloring data for the thread at least based on the embroidery resolution data.

In one embodiment, processing the image data involves deriving stitch data for a plurality of interconnecting stitches, the stitch data comprising a stitch length, a stitching direction and a stitch type.

In one embodiment, generating in-line thread coloring data for the thread comprises transforming the color values to the embroidery resolution data, and extracting color data from said transformed color values in order of a production path as defined by the plurality of interconnecting stitches. The stitch type may be selected from a group comprising satin stitches and straight stitches. The stitch length may be derived as a fixed value.

In one embodiment, wherein the stitch type is straight stitches, generating the embroidery resolution data comprises selecting a first pixel among the plurality of pixels, wherein the position of the first pixel and the stitching direction represents a first embroidery axis, wherein a plurality of embroidery rows is defined in parallel with one another in the direction of the first embroidery axis, calculating a first resolution as a maximum number of stitches fitting a corresponding embroidery row, and calculating a second resolution as a maximum number of stitches fitting an embroidery column being perpendicular to a corresponding embroidery row, wherein the embroidery resolution data is defined by the first and second resolutions.

In one embodiment, wherein the stitch type is satin stitches, generating the embroidery resolution data comprises selecting a first pixel among the plurality of pixels, wherein the position of the first pixel and the stitching direction represents a first embroidery axis, wherein a plurality of embroidery rows is defined in parallel with one another in the direction of the first embroidery axis, calculating a first resolution as a maximum number of stitches fitting an embroidery column being perpendicular to a corresponding embroidery row, and calculating a second resolution as a maximum number of stitches fitting a corresponding embroidery row, wherein the embroidery resolution data is defined by the first and second resolutions.

Generating in-line thread coloring data for the thread may comprise generating transitional colors for underlay stitches. In one embodiment, where generating transitional colors is made for said underlay stitches, it comprises retrieving color data from a first edge portion defined by the in-line thread coloring data, the first edge portion corresponding to a first embroidery row, retrieving color data from a second edge portion defined by the in-line thread coloring data, the second edge portion being opposite from the first edge portion and corresponding to an embroidery row subsequent and parallel to the first embroidery row, generating a color gradient comprising a combination of the color data of the first edge portion and the second edge portion, replacing the color data in the first and second edge portions with color data of the color gradient, and for each subsequent pair of edge portions defined by the in-line thread coloring data, repeating the procedure of retrieving color data from edge portions, generating a color gradient comprising a combination of said retrieved color data, and replacing the color data of the edge portions with the color gradient.

In one embodiment, generating transitional colors for underlay stitches comprises retrieving color data from a first edge defined by the in-line thread coloring data, retrieving color data from a second edge defined by the in-line thread coloring data, generating a color gradient comprising a combination of the color data of the first edge and the second edge, and replacing the color data in the right and left edges with color data of the color gradient.

In one embodiment, generating the color gradient comprises aligning the first and second edges in parallel and subsequent to one another, partitioning the aligned edges into a plurality of portions, and combining the color data of the respective portions according to a color transitioning scheme.

In one embodiment the method further comprise grouping stitches according to the embroidery resolution data.

The method may further comprise performing in-line thread coloring of a thread based on the in-line thread coloring data; and stitching an embroidery pattern using said colored thread.

In one embodiment, a controller for controlling generation of in-line thread coloring data for a thread based on a digital image is provided. The controller is configured to implement the method according to the first aspect.

In one embodiment, a system for use with a thread consuming device is provided. The system comprises a controller being configured to control generation of in-line thread coloring data for a thread based on a digital image according to the second aspect, and a treatment unit being configured to dispense one or more coloring substances according to the in-line thread coloring data onto the thread when activated.

In one embodiment, the system further comprises a thread consuming device being an embroidery machine, a sewing machine, a knitting machine, a weaving machine, a tufting machine, a thread winding machine, or any combination thereof.

Advantages of the embodiments above are that a higher resolution of patterns based on digital images with in-line thread coloring. The patterns have a better color depth as well as being easier to reproduce with high quality. Yet another advantage is the improvement of transitional colors that are achieved. Moreover, the present disclosure provides a more effective use of utilizing underlying stitches to hide unwanted parts. Such unwanted parts may be transitional colors, wrong colored stiches or other “ugly parts”.

Throughout this disclosure, terms such as pixels, stitches, digital image and embroidery pattern will be discussed. It is readily understood that a pixel does necessarily correspond to a stitch, particularly when processing digital images having higher resolution. On the contrary, it is understood that upon generating in-line thread coloring data for a thread, a stitch being used in an embroidery pattern typically corresponds to a plurality of pixels. In the vast majority of cases, the number of stitches in an embroidery pattern being based on a digital image will, therefore, be significantly lower than the number of pixels in said digital image. A natural consequence of this is that color data for a stitch will typically correspond to color values in more than one pixel, i.e. some type of average value of color values for the plurality of pixels will be used to represent color data of a particular stitch. This is the case both when generating embroidery resolution data and in-line thread coloring data. The examples presented and described in this disclosure being directed at rectangular embroidery patterns are merely rectangular due to the relative ease of explanation of said shape. This is, however, by no means limiting to the present disclosure as the digital image or embroidery pattern may be shaped arbitrarily.

Throughout this disclosure, the digital images and embroidery patterns will be described. It is readily understood that the subject-matter of the present disclosure is not limited to actually creating the embroidery pattern. It is, therefore, understood that in-line coloring data can be generated without necessarily stitching the embroidery pattern. In this sense, when stating that something is “defined by” the in-line thread coloring data, e.g. rows, columns or edges pertaining to an embroidery pattern, it is referring to said rows, columns or edges as they would, potentially, be embroidered in the future.

Although the present invention has been described above with reference to specific embodiments, it is not intended to be limited to the specific form set forth herein. Rather, the invention is limited only by the accompanying claims.

In the claims, the term “comprises/comprising” does not exclude the presence of other elements or steps. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an” “first”, “second” etc. do not preclude a plurality. Reference signs in the claims are provided merely as a clarifying example and shall not be construed as limiting the scope of the claims in any way.

1. A controller configured to generate thread coloring data for a thread that is to be used in a creation of a decorative thread pattern, and wherein the controller is further configured to:
generate said thread coloring data based on a digital representation that is to be produced as the decorative thread pattern by:
obtaining pattern data from the digital representation, the pattern data comprising a plurality of pixels, each pixel being associated with a position in the digital representation and a color value;
generating resolution data by processing the pattern data, wherein processing the pattern data comprises determining a thread arrangement comprising a plurality of consecutive thread portions, wherein the entire thread arrangement corresponds to the digital representation to be produced; and
generating thread coloring data for the thread at least based on said resolution data.

2. The controller according to claim 1, wherein processing the pattern data further comprises determining information relating to:
a length of the thread portions,
a direction of the thread portions, and
a type of connection used to connect one or more thread portions to each other.

3. The controller according to claim 2, wherein generating coloring data for the thread comprises:
transforming the color values to the resolution data; and
extracting color data from said transformed color values in order of a production path as defined by the arrangement of the thread portions in relation to each other.

4. The controller according to claim 1, wherein generating the resolution data further comprises:
selecting a first pixel among the plurality of pixels, wherein the position of the first pixel and a production path direction represents a first pixel portion, wherein a plurality of rows are defined in parallel with one another in the direction of the first pixel portion,
calculating a first resolution as a maximum number of connections fitting a corresponding row, and
calculating a second resolution as a maximum number of connections fitting a column being substantially perpendicular to a corresponding row,
wherein the resolution data is defined by the first and second resolutions.

5. The controller according to claim 1, wherein generating the resolution data further comprises:
selecting a first pixel among the plurality of pixels, wherein the position of the first pixel and a production path direction represents a first pixel portion, wherein a plurality of rows are defined in parallel with one another in the direction of the first pixel portion,
calculating a first resolution as a maximum number of connections fitting a column being substantially perpendicular to a corresponding row, and
calculating a second resolution as a maximum number of connections fitting a corresponding row,
wherein the resolution data is defined by the first and second resolutions.

6. The controller according to claim 1, further comprising grouping connections according to the resolution data.

7. The controller according to claim 1, wherein generating thread coloring data for the thread comprises:
generating transitional colors for underlay connections.

8. The controller according to claim 7, wherein generating transitional colors for said underlay connections comprises:
retrieving color data from a first edge portion defined by the thread coloring data, the first edge portion corresponding to a first row,
retrieving color data from a second edge portion defined by the thread coloring data, the second edge portion being opposite from the first edge portion and corresponding to a row subsequent and parallel to the first row,
generating a color gradient comprising a combination of the color data of the first edge portion and the second edge portion,
replacing the color data in the first and second edge portions with color data of the color gradient, and
for each subsequent pair of edge portions defined by the thread coloring data, repeating the procedure of retrieving color data from edge portions, generating a color gradient comprising a combination of said retrieved color data, and replacing the color data of the edge portions with the color gradient.

9. The controller according to claim 7, wherein generating transitional colors for underlay connection comprises:
retrieving color data from a first edge defined by the thread coloring data,
retrieving color data from a second edge defined by the thread coloring data,
generating a color gradient comprising a combination of the color data of the first edge and the second edge, and
replacing the color data in the first and second edges with color data of the color gradient.

10. The controller according to claim 9, wherein generating the color gradient comprises:
aligning the first and second edges in parallel and subsequent to one another,
partitioning the aligned edges into a plurality of portions, and
combining the color data of the respective portions according to a color transitioning scheme.

11. A system for treatment of a thread to be used in a decorative thread pattern, comprising:
a controller configured to generate thread coloring data for a thread that is to be used in a creation of the decorative thread pattern, and wherein the controller is further configured to:
generate said thread coloring data based on a digital representation that is to be produced as the decorative thread pattern by:
obtaining pattern data from the digital representation, the pattern data comprising a plurality of pixels, each pixel being associated with a position in the digital representation and a color value;
generating resolution data by processing the pattern data, wherein processing the pattern data comprises determining a thread arrangement comprising a plurality of consecutive thread portions, wherein the entire thread arrangement corresponds to the digital representation to be produced; and
generating thread coloring data for the thread at least based on said resolution data; and
a treatment unit comprising at least one discharge device being configured to dispense one or more coating substances onto the thread when activated based on the thread coloring data.

12. The system according to claim 11, wherein the controller is further configured to control the dispensing from the discharge device on the thread based on the thread coloring data.

13. The system according to claim 11, wherein the system is for in-line treatment of a thread, and wherein the system is in operative communication with a thread consuming unit that is configured to produce the decorative thread pattern.

14. The system according to claim 11, wherein the decorative thread pattern is an embroidery, the thread arrangement is a stitch pattern, and the plurality of consecutive thread portions is a plurality of consecutive stitches.

15. The system according to claim 11, wherein the decorative thread pattern is a knitted fabric, the thread arrangement is a stitch pattern, and the plurality of consecutive thread portions is a plurality of consecutive stitches.

16. The system according to claim 11, wherein the decorative thread pattern is a woven fabric, the thread arrangement is a weave pattern, and the plurality of consecutive thread portions is a plurality of consecutive interlacing between a warp and a weft.

17. The system according to claim 11, wherein the decorative thread pattern is a sewn fabric, the thread arrangement is a stitch pattern, and the plurality of consecutive thread portions is a plurality of consecutive stitches.

18. The system according to claim 11, wherein the decorative thread pattern is a tufted fabric, the thread arrangement is a tuft pattern, and the plurality of consecutive thread portions is a plurality of consecutive tuft piles.

19. A method for generating thread coloring data for a thread that is to be used in a creation of a decorative thread pattern, the method comprising:
generating said thread coloring data based on a digital representation that is to be produced as the decorative thread pattern by:
obtaining pattern data from the digital representation, the pattern data comprising a plurality of pixels, each pixel being associated with a position in the digital representation and a color values;
generating resolution data by processing the pattern data, wherein processing the pattern data comprises determining a thread arrangement comprising a plurality of consecutive thread portions, wherein the entire thread arrangement corresponds to the digital representation to be produced; and
generating thread coloring data for the thread at least based on said resolution data.

20. The method according to claim 19, further comprising:
dispensing, by a treatment unit and based on the thread coloring data, one or more coating substances onto the thread.
